(19) United States
(12) Patent Application Publication
(10) Pub. No.: US 2007/0266345 A1
(43) Pub. Date: Nov. 15, 2007

(54) METHOD FOR DRIVING DISPLAY WITH REDUCED AGING

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/383,283

(22) Filed: May 15, 2006

(51) Int. Cl. G09G 3/36; G06F 3/048

(52) U.S. Cl. 715/867; 345/101

(57) ABSTRACT

A method of driving a display having a plurality of light-emitting elements that change with time or use, comprising the steps of: a) receiving and displaying a first image signal and storing an attribute of the first image signal; b) receiving and displaying a subsequent second image signal; c) comparing a corresponding image attribute of the subsequent second image signal to the stored first image attribute to form a subsequent second image difference signal; d) displaying a screen saver image signal when the subsequent second image difference signal does not exceed a first limit; e) receiving a plurality of subsequent third image signals while the screen saver image signal is being displayed; f) comparing corresponding image attributes of the subsequent third image signals to the stored first image attribute to form a corresponding plurality of subsequent third image difference signals; and g) displaying a third image signal only when more than one subsequent third image difference signals exceed a second limit.

### FIELD OF THE INVENTION

The present invention relates to a method for driving display devices and more particularly to such a method for reducing differential aging of light-emitting elements of display devices.

### BACKGROUND OF THE INVENTION

Displays comprising a plurality of light-emitting elements, and in particular solid-state organic light-emitting diode (OLED) image display devices, are of great interest as a flat-panel display technology. These displays utilize current passing through thin films of organic material to generate light. The color of light emitted and the efficiency of the energy conversion from current to light are determined by the composition of the organic thin-film material. Different organic materials emit different colors of light. However, as the display is used, the light-emitting elements change with time or use, as the organic materials in the device age and become less efficient at emitting light. This reduces the lifetime of the display. The differing organic materials may age at different rates, causing differential color aging and a display whose white point varies as the display is used. If some light-emitting elements in the display are used more than others, spatially differentiated aging may result, causing portions of the display to be dimmer than other portions when driven with a similar signal. In particular, this may occur when the screen displays a single graphic element in one location for a long period time. Such graphic elements can include stripes or rectangles with background information, for example such as news headlines and sports scores, network logos, and the like. Differences between a signal and a display aspect ratio are also problematic.

Computer monitors typically employ screen savers that are automatically displayed when no user interaction has been detected for a pre-determined period of time. The screen savers may either blank the screen or employ a variable image signal to prevent excessive aging, in particular localized aging. However, for entertainment applications, user interaction may be infrequent and localized aging can become a problem for displays that are susceptible to this problem.

Television broadcasts may have a variety of signal variations, even when an effectively static image is conveyed. For example, transmissions are subject to a variety of noise factors that can slightly change the signal. Any digitization of the analog signal may result in slight output variations that result from these signal variations, as well as inherent noise in the digitization process. Moreover, a live broadcast of a static scene may have slight variations in camera location that will result in similar variability. Hence, two frames that are ostensibly identical, when processed within a consumer's television receiver, will have minor differences and a comparative method for detecting static images that relies on an identical match may fail inappropriately. In other cases, a scene may be largely static but have one small area that varies significantly. For example, a web page may have completely static content except for a clock or continuously updated text in one small area. Such a scene may also be problematic with respect to avoiding burn-in in a display. In yet another case, a single frame interruption of a static scene broadcast (for example with an intermittent electromagnetic interference in the broadcast system) may be incorrectly interpreted as a cessation of a static image broadcast. Likewise, horizontal or vertical sync variability may produce a similar, deleterious effect. Digital signals may have other problems with signal corruption, for example blocking errors or decompression faults, or a broadcast signal may be interrupted. Use of a screen saver as taught in the prior art or the employment of a time-out as used in display monitor applications, may result in an unpleasant viewing experience of noisy signals under such circumstances. Moreover, the display of such noisy signals can result in driving the display harder than necessary, thereby reducing the lifetime of the display.

The application of screen saving signals in an entertainment display such as a television is known in the prior art. Referring to FIG. 1, in a typical, simple solution, an image signal 100 is received and image attributes formed 105. The received image is displayed 110 and the attributes stored 115. A new image signal is received 120 and image attributes for the new signal formed 125. The new image attributes are compared 130 to the stored image attributes and, if 135 the image attributes are different, the process repeats by displaying 110 the new image, storing 115 the image attributes, and a next, new image received 120. However, if 135 the image attributes are the same, the display enters 140 a screen saver mode.

Referring to FIG. 2, while in screen saver mode a screen saver image signal is displayed 150. A next, new image signal is then received 155, its image attributes formed 160, and compared 165 to the stored image attributes. If 170 the image attributes are the same, the process repeats by displaying 150 the screen saver and a next, new image received 155 so that the process repeats. However, if 170 the image attributes are different, the display returns 175 to step 110 (FIG. 1). Typically, the image attributes are the image pixels themselves and the difference calculation is a comparison of pixels between the stored and current images. Hence, an image frame store is required. If the two images are the same, or the differences do not exceed a pre-determined limit, a judgment is made that the images are static and that a screen saver signal should be displayed.

The general problem of regional brightness differences due to icon burn-in of specific areas due to video content has been addressed in the prior art, for example by U.S. Pat. No. 6,856,328 B2 entitled, “System and method of displaying images.” Logos may be present in images transmitted by television stations. These logos are often present in the corners of an image for a long time. They do not move and may comprise saturated colors. This results in burn-in effects in emissive displays because the logos provide the same display load at the same location for a relatively long period of time. The burn-in effect can be prevented by detecting the logos in the corners of the image and reducing their intensity to the average display load. Alternatively, US20050246657 A1 entitled “Video display arrangement including image processing circuitry for protecting display and method of protecting a video display” describes a video display arrangement that includes a display and a receiver. The receiver includes video imaging processing circuitry, the circuitry including a video formatter adapted to transmit formatted active image signals, a display buffer having a video display memory for temporarily storing the active image signals and transferring the active image signals to a display, a comparator for comparing one or more blocks of the video display memory for changing content over time and sending a static content warning signal to the video formatter when content in the one or more blocks remains static beyond a predetermined static content period, and program storage including one or more programs adapted to cause the video formatter to transfer a changing content image to the display buffer after receiving the static content warning signal. However, this approach may not be not robust in the face of interference or noise in the signal.

U.S. Pat. No. 6,313,878 B 1 entitled “Method and structure for providing an automatic hardware-implemented screen-saver function to a display product” describes a hardware-implemented screen-saver that prevents burn-in of an image displayed on a screen of a display product by automatically reducing the video gain, and therefore the contrast, of the image when the portion of the image within a two-dimensional detection window has changed by less than a predetermined amount for a predetermined period of time. A lack of change of the incoming video signal of the image is detected and used to invoke a reduction in contrast of the image displayed on the display product. This allows the image to remain visible, yet reduces the possibility of burn-in of the image in the screen of the display product. This disclosure describes the use of voltage averaging circuits and checksums, thereby mitigating the need for a frame-store. It also describes the use of user-defined windows for selecting a portion of an image signal. However, this embodiment may require user interaction, be limited to a single sampling window, and fail to be robust in the presence of noise or interference in the signal.

There is a need, therefore, for an improved method of detecting image signals that can cause localized burn-in for a display having a plurality of light-emitting elements having outputs that change with time or use.

### SUMMARY OF THE INVENTION

In accordance with one embodiment, the invention is directed towards a method of driving a display having a plurality of light-emitting elements that change with time or use, comprising the steps of: a) receiving and displaying a first image signal and storing an attribute of the first image signal; b) receiving and displaying a subsequent second image signal; c) comparing a corresponding image attribute of the subsequent second image signal to the stored first image attribute to form a subsequent second image difference signal; d) displaying a screen saver image signal when the subsequent second image difference signal does not exceed a first limit; e) receiving a plurality of subsequent third image signals while the screen saver image signal is being displayed; f) comparing corresponding image attributes of the subsequent third image signals to the stored first image attribute to form a corresponding plurality of subsequent third image difference signals; and g) displaying a third image signal only when more than one subsequent third image difference signals exceed a second limit.

In accordance with a second embodiment, the invention is directed towards a method of driving a display having a plurality of light-emitting elements that change with time or use, comprising the steps of: a) receiving and displaying a first image signal and storing an attribute of the first image signal; b) receiving and displaying a plurality of subsequent second image signals; c) comparing corresponding image attributes of the subsequent second image signals to the stored first image attribute to form a corresponding plurality of subsequent second image difference signals; and d) displaying a screen saver image signal only when more than one subsequent second image difference signals do not exceed a first limit, wherein the more than one subsequent second image difference signals not exceeding the first predetermined limit required to display the screensaver image signal may be separated in time by at least one subsequent second image difference signal that exceeds the first limit.

### ADVANTAGES

The advantages of this invention include providing a display system that reduces aging of the display and is robust in the presence of noise or interference in the signal.

### BRIEF DESCRIPTION OF THE DRAWINGS

FIG. 1 is a flow diagram of a screen saving method as described in the prior art;

FIG. 2 is a flow diagram of a screen saving method as described in the prior art;

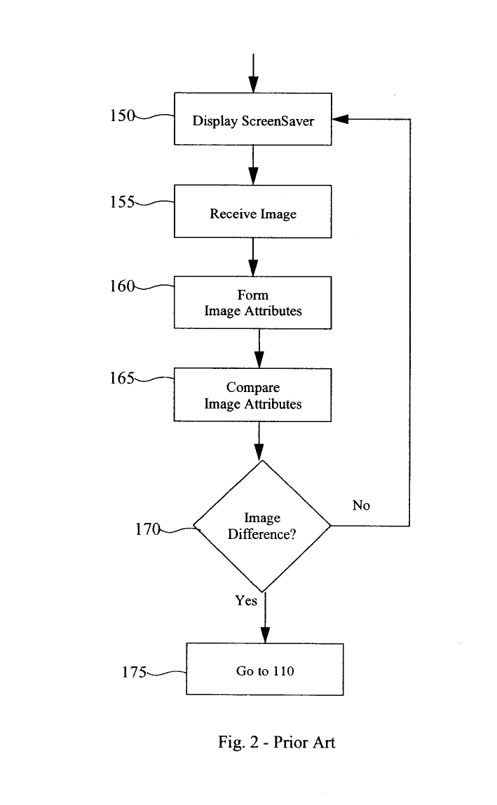

FIG. 3 is a flow diagram of the method according to an embodiment of the present invention;

FIG. 4 is a flow diagram of the method according to another embodiment of the present invention; and

FIG. 5 is a schematic diagram of a system for implementing the method of the present invention.

### DETAILED DESCRIPTION OF THE INVENTION

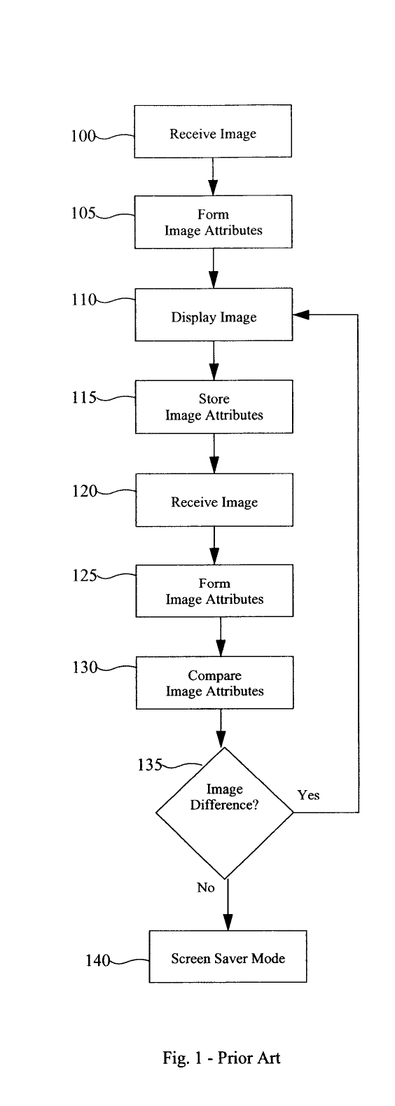

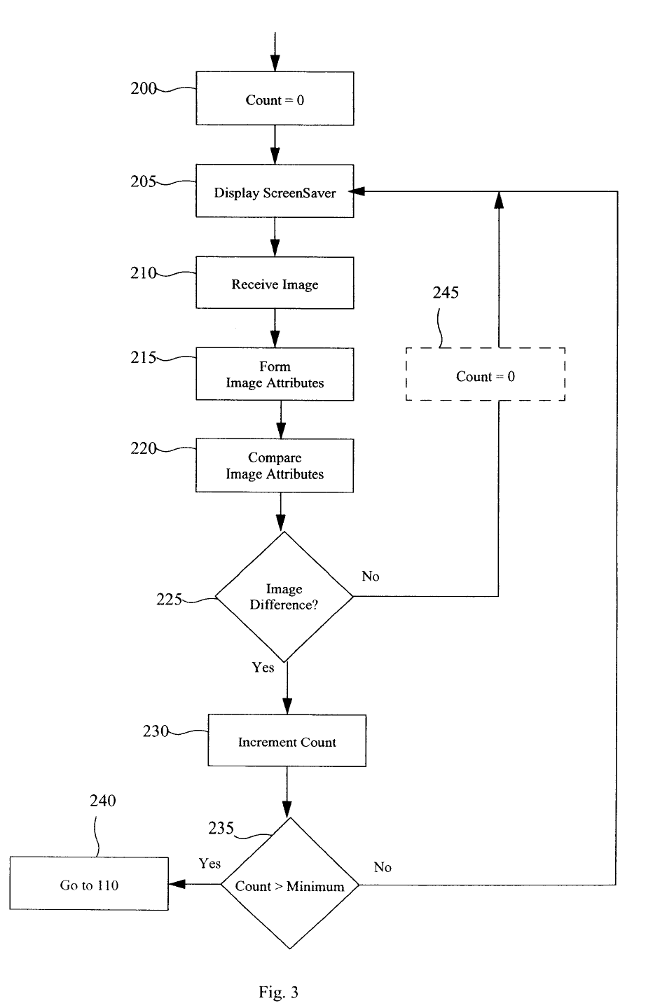

Referring to FIGS. 1 and 3, a method of driving a display having a plurality of light-emitting elements that change with time or use, comprises the steps of receiving 100 an image, forming 105 image attributes, and displaying 110 a first image signal, and then storing 115 an attribute of the first image signal. A subsequent second image signal is received 120, corresponding image attributes formed 125, and compared 130 to the stored first image attribute to form a subsequent second image difference signal that is tested 135 against a first limit. When the subsequent second image difference signal does not exceed the first limit, a screen saver image signal is displayed 140. If the subsequent second image difference signal does exceed the first limit, the subsequent second image is displayed 110 and the process repeats. Referring to FIG. 3, in accordance with one embodiment of the invention, a counter is initialized 200 and the screen saver image signal is displayed 205. A plurality of subsequent third image signals are received 210, corresponding image attributes of the subsequent third image signals are formed 215 and compared 220 to the stored first image attribute to form a corresponding plurality of subsequent third image difference signals. The image difference signals are tested 225 against a second limit. If the image difference signal is less than the second limit, the screen signal continues to be displayed 205. If the image difference signal is greater than the second limit, the counter is incremented 230 and the counter value is tested 235. When more than one subsequent third image difference signal has been found to exceed the second limit such that the count value becomes greater than a minimum (and more than one in accordance with the invention), a third image signal is displayed by going 240 to step 110, at which point the screen save mode is no longer operative and the process begins again. While the number of subsequent third image difference signals that exceed 235 the second limit is less than the required minimum, the screen saver continues to be displayed 205 and the next input image is received 210 and examined and the process continues as described above. The number of subsequent third image difference signals required to exceed the second limit may be specified by any desired minimum value greater than one.

In various embodiments of the present invention, the subsequent third image difference signals that exceed the second limit may or may not be required to be sequential and continuous in time to exit the screen saver mode and not display the screen saver image signal. Where a number of sequential and continuous in time subsequent third image difference signals are required to exceed the second limit to display a subsequent third image signal, such an embodiment may be readily implemented by resetting 245 the counter to zero each time a third image signal is received that does not exceed the difference limit, i.e. is a static image. Alternatively, the more than one subsequent third image difference signals exceeding the second limit required to display the subsequent third image signal may be separated in time by at least one subsequent third image difference signal that does not exceed the second limit. In this case, the counter of FIG. 3 is not reset to zero in step 245. As may be understood by one skilled in the art, a variety of limitations on the number and limits of images that do, or do not, exceed the second limit may be provided to control the durability of the screen saver modes. A user may select the number of subsequent third image difference signals that are required to exceed the second limit to display a subsequent third image signal. Various limits on the number of sequential images received or the acceptable differences between them may be employed. One or more temporary interruptions in an otherwise effectively static image stream may be tolerated with various number or acceptable differences.

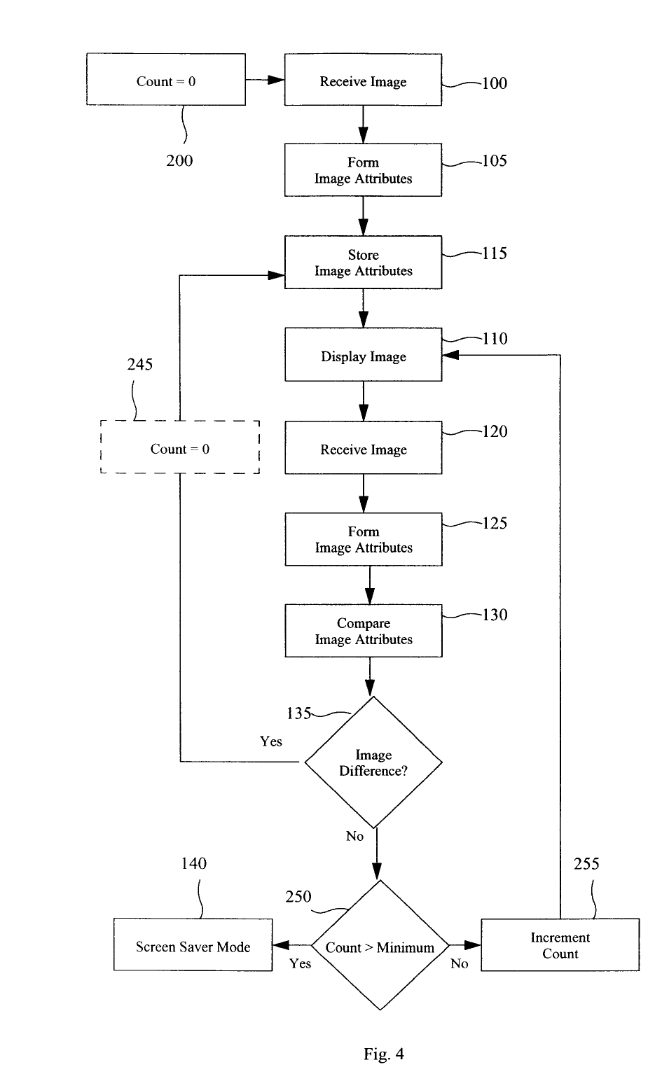

In an alternative embodiment of the present invention, a plurality of subsequent second image signals may be employed, and a corresponding plurality of second image difference signals tested against a first limit. For each subsequent second image signal, corresponding image attributes of the subsequent second image signals are compared to the stored first image attribute to form a corresponding plurality of subsequent second image difference signals; and a screen saver image signal is displayed only when more than one subsequent second image difference signals do not exceed a first limit, wherein the more than one subsequent second image difference signals not exceeding the first predetermined limit required to display the screensaver image signal may be separated in time by at least one subsequent second image difference signal that exceeds the first limit. Referring to FIG. 4, in such embodiment, a counter may first be set 200 to zero, a first image received 100, image attributes formed 105 and stored 115, and the image displayed 110. A subsequent second image is received 120, attributes formed 125, and compared 130 to the stored corresponding first image attribute to form a second image difference signal. The difference is tested 135 against the first limit and, if a difference is found, the process repeats by storing the attributes 115, displaying 110 the image and continuing as described above. If a sufficient difference is not found, the counter is tested 250 and, if it exceeds a minimum, the process enters 140 the screen saver mode of FIG. 3. If the counter does not exceed the minimum, the counter is incremented 255, the image displayed 110 and the process repeats again. Hence, a screensaver image signal is only displayed when the count exceeds a minimum (i.e., more than one subsequent second image difference signals have not exceeded the first limit).

In an alternative embodiment when employing a plurality of subsequent second image signals, the subsequent second image difference signals that exceed the first limit may be required to be sequential and continuous in time to enter the screen saver mode and display the screen saver image signal. Such an embodiment may be readily implemented in the embodiment of FIG. 4 by resetting 245 the counter to zero each time a subsequent second image signal is received that exceeds the difference limit.

In various embodiments of the present invention, the first and second limits may be the same limit. In this case, the requirements for detecting differences between image signals are the same for entering screen saver mode as for exiting screen saver mode. In other embodiments, it may be preferred that the first and second limits be different. For example, it may be preferred to have more stringent limits for entering screen saver mode than for exiting screen saver mode. Likewise, the number of second difference signals that meet the first limit requirement for indicating a static signal and entering screen saver mode may be the same, or different, from the number of third difference signals that do not meet the second limit requirement for indicating a static signal. For example, it may be preferred to require relatively more second difference signals to be within the first limit to enter screen saver mode and relatively fewer third difference signals to be without the second limit for exiting screen saver mode. Alternatively, the number of second or third difference signals meeting the relevant limit requirements necessary to enter or exit screen saver mode may be selected by a user.

As noted above, a variety of first and second limit values may be employed or selected by a user. Similarly, various numbers of difference signals compared to these limits may be required to change screen saver mode. In an alternative embodiment, the first limit is determined as a function of the luminance of the first image signal. In such an embodiment, e.g., limits may be set so that brighter signal streams may more quickly employ a screen saver. Likewise, the required number of second difference signals meeting the relevant limits may change depending on the luminance of the first image signal. It is also possible to set the second limit and/or number of third difference signals depending on the luminance of the first, second, or third received signals.

A variety of image attributes may be employed in various embodiments of the present invention. One attribute may be employed or, alternatively, a plurality of attributes may be formed for each image received. In this case, a plurality of image attributes of the subsequent second image signal are compared to a plurality of corresponding first image attributes to form the subsequent second image difference signal. Likewise, a plurality of image attributes of the subsequent third image signal are compared to a plurality of corresponding first image attributes to form the subsequent third image difference signal.

The image attributes may comprise one or more values of the corresponding image signals themselves, such that the comparisons are comparisons of the image signal values. That is, the image attributes correspond to the image pixel values themselves. In this case, the image attributes are essentially the image and the present invention explicitly includes this case. Alternatively, the image may be processed in some fashion to form image attributes that characterize the image and can be compared to form a useful difference signal. For example, image attributes useful for detecting static digital image signals and the degree of image change in an image signal may include one or more of the following: the result of a logical exclusive OR or logical exclusive NOR applied to the pixels in the image, an average value of the pixels in the image, a sum of the pixel values in the image, a multi-value reduced resolution array representing the pixels in the image, and the spatial location of the pixels in the image. In the analog signal domain, attributes may include one or more of the following: an average of the pixel values in the image, a sum of the pixel values in the image, a multi-value reduced resolution array representing the pixels in the image, and the spatial location of the pixels in the image.

Generally, attributes that are formed by a logical combination of digital values (for example, an exclusive OR operation performed on the pixels in an image) will form a single value having two states that can be directly compared to the corresponding attribute of another image signal. Any difference, however small, will indicate that a match is not made and there is no effective measure of the degree of difference. This can be a useful attribute but tends not to be robust when used alone, since any minor noise or error in the system will indicate that a match is not present. Computations providing an average value or sum of pixel elements are much more robust in the presence of noise, but can on the contrary produce a false positive comparison since two different images may have very different content and yet produce a similar average or sum. A more complex attribute may be formed by a reduced resolution version of an image. Such a multi-value attribute may be, for example, correlated with a corresponding and similar attribute from another image signal to provide a much more sophisticated measure of difference. An extremely useful factor in forming an image attribute considers the location of pixels within the two-dimensional array of the image signal.

In a preferred embodiment of the present invention, a plurality of attributes describing the similarity between two image signals may be employed. These attributes may be compared to each other to form a difference value (either logical or computational). The difference value may be compared to a predetermined metric, for example a threshold value, to provide a difference value that represents the likelihood or extent of image similarity. At this point, each attribute (either logical or computational) is indicative of differences between the two different images. The various attributes may then be combined to form a combined value representative of the overall likelihood and extent of image signal similarity and may then be compared to a predetermined metric to make a judgment whether to employ, or cease employing, a screen saver signal.

In one embodiment of the present invention, the image attributes may be computational, for example a difference of sums or a correlation of a multi-value reduced resolution array for the corresponding images. These attribute values may be compared to a predetermined metric to obtain a logical value for each image.

In a preferred embodiment of the present invention, the comparison of pixels in an image signal may be weighted by the spatial location of the pixel within the two-dimensional image signal. (Alternatively, the calculation of the difference signal values may be so weighted.) For example, it is likely that minor changes in an otherwise static image, for example time indicators (digital or analog clocks) will be located in a corner of an image, stock tickers may be located on the bottom or top of an image, as will sports scores, weather updates, or minor changes in web pages. Such changes may be acceptable in image signals and the image signals may still be considered static for a particular application. Hence by weighting the pixels at the edge of an image signal, a more acceptable decision may be made.

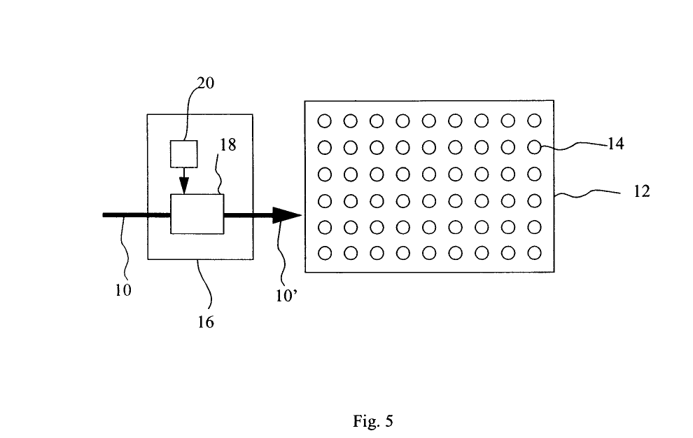

Referring to FIG. 5, a system enabling the method of the present invention may comprise a display 12 having light-emitting elements 14 arranged in a two-dimensional array corresponding to the pixels of the image signals. A controller 16 may receive an image signal 10 and perform the method of the present invention using digital logic 18, with or without volatile or non-volatile memory 20. If analog input is employed, an analog to digital converter, not shown, may be used to convert the image signal to a form suitable for processing. The controller 16 may also convert the image signal 10 into a form 10′ suitable for driving the display 12 (for example by providing appropriate voltage levels and timing signals). Digital and analog circuitry are known in the art for performing such operations for example with display controller chips, digital logic circuits, and digital signal processors.

According to the present invention, the screen saver signal is an image signal displayed on the display that preserves the lifetime of the display, reduces the power used by the display, or preserves the lifetime or reduces the power used by the system of which the display is a part. For example, a screen saver image signal may be a dark signal (i.e. a black image), a scene or graphic that changes over time, a darkened second image signal, or an image signal wherein every pixel changes over time. A dark signal both reduces the power used by a display and improves the lifetime of the display. Similarly, a darkened image signal (i.e. an image signal that presents a scene but at a reduced luminance) will both reduce the power used by a display and improve the lifetime of the display. A scene or graphic that changes over time can reduce the burn-in of a display as can an image signal wherein every pixel changes over time.

In various embodiments of the present invention, the image signals may be high-definition television format signals or standard definition television format signals. Conventional broadcast television signals are analog while some modern televisions employ a digital signal distributed, for example, by cable. The present invention may be employed in both modalities. Analog signals may be digitized and attributes formed digitally or, by employing analog circuitry such as operational amplifiers, transistors, and capacitors, the attributes may be formed in the analog domain. Digital signals may be processed digitally and will not generally be transformed to the analog domain to form the group attributes.

The present invention can provide useful means to detect static image signals and provide screen saving signals suitable for improving display lifetime and reducing power usage. By employing attributes rather than entire images for comparison, storage may be reduced. In the case of analog signals that have corrupted sync signals or errors in digitization, ghosting, or digital signals that have blocking or decompression errors, the use of correlation and average or sums can provide a robust measure of change. Likewise, camera shake (slight variations in scene positions) may be overcome with similar attributes. Frame interruption may be suitably ignored by requiring a series of consecutive frames to be judged similarly. In the case in which scenes have one small area that changes but are otherwise static, by weighting the areas that are likely to have the changes lower, a scene may be properly judged to be static. Interrupted broadcast signals may be suitably dealt with, either for dropped frames or for incorrect inserted frames causing flicker.

In a preferred embodiment of the present invention, the display is an OLED display and the invention is employed in a device that includes Organic Light-emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device. In other embodiments, the present invention is employed in plasma display devices.

The present invention can be employed in most OLED device configurations. These include very simple structures comprising a single anode and cathode to more complex devices, such as passive-matrix displays comprised of orthogonal arrays of anodes and cathodes to form light-emitting elements, and active-matrix displays where each light-emitting element is controlled independently, for example, with thin film transistors (TFTs). It may be employed in both top- and bottom-emitter configurations.

The invention has been described in detail with particular reference to certain preferred embodiments thereof, but it will be understood that variations and modifications can be effected within the spirit and scope of the invention.

PARTS LIST

| | |
|---|---|
| 10, 10′ | image signal |
| 12 | display |
| 14 | light-emitting element |
| 16 | controller |
| 18 | digital logic |
| 20 | memory |
| 100 | receive image signal step |
| 105 | form image attributes step |
| 110 | display image signal step |
| 115 | store image attributes step |
| 120 | receive image step |
| 125 | form image attributes step |
| 130 | compare image attributes step |
| 135 | test image attributes step |
| 140 | go to screen saver mode step |
| 150 | display screen saver step |
| 155 | receive image signal step |
| 160 | form image attributes step |
| 165 | compare image attributes step |
| 170 | test image attributes step |
| 175 | go to step 110 step |
| 200 | set counter step |
| 205 | display screen saver step |
| 210 | receive image step |
| 215 | form image attributes step |
| 220 | compare image attributes step |
| 225 | test image attributes step |
| 230 | increment counter step |
| 235 | test counter step |
| 240 | Go to step 110 step |
| 245 | set counter to zero step |
| 250 | test counter step |
| 255 | increment counter step |

1. A method of driving a display having a plurality of light-emitting elements that change with time or use, comprising the steps of:
a) receiving and displaying a first image signal and storing an attribute of the first image signal;
b) receiving and displaying a subsequent second image signal;
c) comparing a corresponding image attribute of the subsequent second image signal to the stored first image attribute to form a subsequent second image difference signal;
d) displaying a screen saver image signal when the subsequent second image difference signal does not exceed a first limit;
e) receiving a plurality of subsequent third image signals while the screen saver image signal is being displayed;
f) comparing corresponding image attributes of the subsequent third image signals to the stored first image attribute to form a corresponding plurality of subsequent third image difference signals; and
g) displaying a third image signal only when more than one subsequent third image difference signals exceed a second limit.

2. The method of claim 1, further comprising the step of receiving a plurality of subsequent second image signals, comparing corresponding image attributes of the subsequent second image signals to the first image attribute to form a corresponding plurality of second image difference signals, and displaying a screensaver image signal only when more than one subsequent second image difference signals do not exceed the first limit.

3. The method of claim 2, wherein the first and second limits are the same.

4. The method of claim 2, wherein a different number of subsequent third image difference signal are required to exceed the second limit to display a third image signal than the number of subsequent second image difference signals required not to exceed the first limit to display the screensaver image signal.

5. The method of claim 2, wherein a number of sequential and continuous in time subsequent second image difference signals are required not to exceed the first limit to display the screensaver image signal.

6. The method of claim 2, wherein the more than one subsequent second image difference signals not exceeding the first limit required to display the screensaver image signal may be separated in time by one or more subsequent second image difference signal that exceeds the first limit.

7. The method of claim 2, wherein the first limit is determined as a function of the luminance of the first or second image signal.

8. The method of claim 2, wherein the number of subsequent second image difference signals required not to exceed the first limit to display the screensaver image signal is determined as a function of the luminance of the first image signal.

9. The method of claim 1, wherein a number of sequential and continuous in time subsequent third image difference signals are required to exceed the second limit to display a subsequent third image signal.

10. The method of claim 1, wherein the more than one subsequent third image difference signals exceeding the second limit required to display a subsequent third image signal may be separated in time by one or more subsequent third image difference signal that does not exceed the second limit.

11. The method of claim 1, wherein a user selectable number of subsequent third image difference signals are required to exceed the second limit to display a subsequent third image signal.

12. The method of claim 1, wherein the first limit is determined as a function of the luminance of the first image signal.

13. The method of claim 1, wherein a plurality of image attributes of the subsequent second image signal are compared to a plurality of corresponding first image attributes to form the subsequent second image difference signal.

14. The method of claim 1, wherein a plurality of image attributes of the subsequent third image signals are compared to a plurality of corresponding first image attributes to form the subsequent third image difference signals.

15. The method of claim 1, wherein the image attributes comprise one or more values of the corresponding image signals themselves, and the comparisons are comparisons of the image signal values.

16. The method of claim 1, wherein the screensaver image is a dark image signal, a scene or graphic that changes over time, a darkened second image signal, or an image signal wherein every pixel changes over time.

17. The method of claim 1, further comprising the step of accepting a user-interaction signal, receiving and displaying a first image, and storing an attribute of the first image signal.

18. The method of claim 1, wherein the first, second and third image signals are high-definition television or standard definition television format signals.

19. The method of claim 1, wherein the display is an OLED display.

20. A method of driving a display having a plurality of light-emitting elements that change with time or use, comprising the steps of:
a) receiving and displaying a first image signal and storing an attribute of the first image signal;
b) receiving and displaying a plurality of subsequent second image signals;
c) comparing corresponding image attributes of the subsequent second image signals to the stored first image attribute to form a corresponding plurality of subsequent second image difference signals; and
d) displaying a screen saver image signal only when more than one subsequent second image difference signals do not exceed a first limit, wherein the more than one subsequent second image difference signals not exceeding the first predetermined limit required to display the screensaver image signal may be separated in time by at least one subsequent second image difference signal that exceeds the first limit.
